(19) United States
(12) Patent Application Publication
(10) Pub. No.: US 2025/0203652 A1
(43) Pub. Date: Jun. 19, 2025

(54) TECHNIQUES FOR RAPID COMMUNICATION OF PRIORITY SIGNALING

(71) Applicant: QUALCOMM Incorporated, San Diego, CA (US)

(72) Inventors: Qian ZHANG, Basking Ridge, NJ (US); Junyi LI, Fairless Hills, PA (US); Juergen CEZANNE, Ocean Township, NJ (US); Vasanthan RAGHAVAN, West Windsor Township, NJ (US)

(21) Appl. No.: 18/539,017

(22) Filed: Dec. 13, 2023

(51) Int. Cl. H04W 74/0808; H04L 5/14

(52) U.S. Cl. CPC H04W 74/0808; H04L 5/14

(57) ABSTRACT

Methods, systems, and devices for wireless communication are described. A first user equipment (UE) may operate in a full duplex mode, and may receive a control signal associated with a low data rate from a second UE while transmitting a signal to a third UE. The control signal may be received at the first UE according to a reduced detection threshold. The second and third UEs may or may not be the same UE, and the control signal may indicate that the second UE has priority signaling for the first UE. In some cases, the first UE may communicate control signaling configuring various aspects of the control signal based on a distance between the first UE and the second UE or self-interference associated with the first UE. The second UE may transmit the priority signal based on determining that the first UE transitioned to operating in a receive mode.

### FIELD OF TECHNOLOGY

The following relates to wireless communication, including techniques for rapid communication of priority signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for rapid communication of priority signaling. For example, the described techniques provide for a first user equipment (UE) (e.g., a vehicle-to-everything (V2X) UE, sidelink UE) to operate in a full duplex (FD) mode, and to receive a control signal associated with a low data rate from a second UE while concurrently transmitting a signal to a third UE, such that the control signal may be received at the first UE according to a reduced detection threshold (e.g., a reduced signal-to-interference-and-noise ratio (SINR), reduced compared to a regular or legacy detection threshold). The second and third UEs may be the same UE or may be different UEs, and the control signal may indicate that the second UE has an urgent message to send to the first UE. In some cases, the first UE may communicate control signaling (e.g., with the second UE, the third UE, or both) configuring various aspects of the control signal based on a distance between the first UE and the second UE, a signal isolation capability of the first UE, self-interference associated with the first UE, or any combination thereof. Additionally, or alternatively, the second UE may transmit the priority signal based on determining that the first UE transitioned from operating in the FD mode to operating in a receive mode.

A method for wireless communications by a first wireless device is described. The method may include transmitting a first signal from the first wireless device during operation of the first wireless device in a FD mode, where operation in the FD mode includes a capability to simultaneously operate in a transmit mode and a receive mode, receiving, during transmission of the first signal, a control signal that is indicative that a priority signal is intended for the first wireless device, and receiving the priority signal after a transition of the first wireless device from operation in the FD mode to operation in the receive mode, where the transition is based on reception of the control signal.

A first wireless device for wireless communications is described. The first wireless device may include one or more memories storing processor executable code, and one or more processors coupled with the one or more memories. The one or more processors may individually or collectively operable to execute the code to cause the first wireless device to transmit a first signal from the first wireless device during operation of the first wireless device in a FD mode, where operation in the FD mode includes a capability to simultaneously operate in a transmit mode and a receive mode, receive, during transmission of the first signal, a control signal that is indicative that a priority signal is intended for the first wireless device, and receive the priority signal after a transition of the first wireless device from operation in the FD mode to operation in the receive mode, where the transition is based on reception of the control signal.

Another first wireless device for wireless communications is described. The first wireless device may include means for transmitting a first signal from the first wireless device during operation of the first wireless device in a FD mode, where operation in the FD mode includes a capability to simultaneously operate in a transmit mode and a receive mode, means for receiving, during transmission of the first signal, a control signal that is indicative that a priority signal is intended for the first wireless device, and means for receiving the priority signal after a transition of the first wireless device from operation in the FD mode to operation in the receive mode, where the transition is based on reception of the control signal.

A non-transitory computer-readable medium storing code for wireless communications is described. The code may include instructions executable by one or more processors to transmit a first signal from the first wireless device during operation of the first wireless device in a FD mode, where operation in the FD mode includes a capability to simultaneously operate in a transmit mode and a receive mode, receive, during transmission of the first signal, a control signal that is indicative that a priority signal is intended for the first wireless device, and receive the priority signal after a transition of the first wireless device from operation in the FD mode to operation in the receive mode, where the transition is based on reception of the control signal.

In some examples of the method, first wireless devices, and non-transitory computer-readable medium described herein, the control signal may be a waveform, a sequence, or a reference signal that, upon reception, may be indicative that the priority signal may be intended for the first wireless device.

In some examples of the method, first wireless devices, and non-transitory computer-readable medium described herein, the waveform, the sequence, or the reference signal may be each part of a set of waveforms, a set of sequences, or a set of reference signals, respectively and each of the set of waveforms, the set of sequences, or the set of reference signals may be associated with indication of priority signaling.

Some examples of the method, first wireless devices, and non-transitory computer-readable medium described herein may further include operations, features, means, or instructions for receiving a second control signal that indicates that the waveform, the sequence, or the reference signal may be associated with indication of priority signaling on a per device bases.

In some examples of the method, first wireless devices, and non-transitory computer-readable medium described herein, reception of the control signal during transmission of the first signal may be facilitated by the control signal having a data rate that may be less than a data rate threshold, reception at the first wireless device at a first data rate that may be less than the data rate threshold may be associated with a first detection threshold at the first wireless device, and reception at the first wireless device at a second data rate that may be greater than the data rate threshold may be associated with a second detection threshold that may be greater than the first detection threshold.

In some examples of the method, first wireless devices, and non-transitory computer-readable medium described herein, the first detection threshold may be a SINR threshold.

Some examples of the method, first wireless devices, and non-transitory computer-readable medium described herein may further include operations, features, means, or instructions for participating in communication of one or more second control signals that configure a monitoring window for reception of the control signal at the first wireless device.

In some examples of the method, first wireless devices, and non-transitory computer-readable medium described herein, the monitoring window includes a symbol or a slot or a mini-slot boundary.

Some examples of the method, first wireless devices, and non-transitory computer-readable medium described herein may further include operations, features, means, or instructions for participating in communication of one or more second control signals that configure a length of the control signal, a quantity of repetitions of the control signal, or both.

In some examples of the method, first wireless devices, and non-transitory computer-readable medium described herein, the length of the control signal, the quantity of repetitions of the control signal, or both, may be based on a distance between the first wireless device and a source of the control signal, a signal isolation capability of the first wireless device, a self-interference measurement associated with the first wireless device, or any combination thereof.

In some examples of the method, first wireless devices, and non-transitory computer-readable medium described herein, the one or more second control signals include a broadcast message broadcast by the first wireless device, an initial connection message transmitted by the first wireless device to a source of the control signal, a periodic control message transmitted by the first wireless device, a response message transmitted by the first wireless device responsive to reception of the control signal, or any combination thereof.

Some examples of the method, first wireless devices, and non-transitory computer-readable medium described herein may further include operations, features, means, or instructions for transmitting a termination signal based on reception of the control signal, where the termination signal indicates a termination of transmission of the first signal.

In some examples of the method, first wireless devices, and non-transitory computer-readable medium described herein, reception of the priority signal may be based on transmission of the termination signal.

In some examples of the method, first wireless devices, and non-transitory computer-readable medium described herein, at least one of the first signal, the control signal, or the priority signal may be a part of a V2X communication, a sidelink communication, a network access communication, or any combination thereof.

A method for wireless communications by a second wireless device is described. The method may include transmitting a control signal to a first wireless device during operation of the first wireless device in a FD mode and during transmission, by the first wireless device, of a first signal, where the control signal is indicative that a priority signal is intended for the first wireless device and transmitting the priority signal to the first wireless device based on determining that an operational mode of the first wireless device is a receive mode based on transmission of the control signal.

A second wireless device for wireless communications is described. The second wireless device may include one or more memories storing processor executable code, and one or more processors coupled with the one or more memories. The one or more processors may individually or collectively operable to execute the code to cause the second wireless device to transmit a control signal to a first wireless device during operation of the first wireless device in a FD mode and during transmission, by the first wireless device, of a first signal, where the control signal is indicative that a priority signal is intended for the first wireless device and transmit the priority signal to the first wireless device based on determining that an operational mode of the first wireless device is a receive mode based on transmission of the control signal.

Another second wireless device for wireless communications is described. The second wireless device may include means for transmitting a control signal to a first wireless device during operation of the first wireless device in a FD mode and during transmission, by the first wireless device, of a first signal, where the control signal is indicative that a priority signal is intended for the first wireless device and means for transmitting the priority signal to the first wireless device based on determining that an operational mode of the first wireless device is a receive mode based on transmission of the control signal.

A non-transitory computer-readable medium storing code for wireless communications is described. The code may include instructions executable by one or more processors to transmit a control signal to a first wireless device during operation of the first wireless device in a FD mode and during transmission, by the first wireless device, of a first signal, where the control signal is indicative that a priority signal is intended for the first wireless device and transmit the priority signal to the first wireless device based on determining that an operational mode of the first wireless device is a receive mode based on transmission of the control signal.

Some examples of the method, second wireless devices, and non-transitory computer-readable medium described herein may further include operations, features, means, or instructions for receiving the first signal from the first wireless device, where transmitting the control signal may be based on reception of the first signal.

In some examples of the method, second wireless devices, and non-transitory computer-readable medium described herein, the control signal may be a waveform, a sequence, or a reference signal that may be indicative to a receiver that the priority signal may be intended for the first wireless device.

In some examples of the method, second wireless devices, and non-transitory computer-readable medium described herein, the waveform, the sequence, or the reference signal may be each part of a set of waveforms, a set of sequences, or a set of reference signals, respectively and each of the set of waveforms, the set of sequences, or the set of reference signals may be associated with indication of priority signaling on a per device bases.

Some examples of the method, second wireless devices, and non-transitory computer-readable medium described herein may further include operations, features, means, or instructions for receiving a second control signal that indicates that the waveform, the sequence, or the reference signal may be associated with indication of priority signaling for the first wireless device corresponding to the second wireless device.

In some examples of the method, second wireless devices, and non-transitory computer-readable medium described herein, the control signal may have a data rate that may be less than a data rate threshold.

Some examples of the method, second wireless devices, and non-transitory computer-readable medium described herein may further include operations, features, means, or instructions for participating in communication of one or more second control signals that configure a monitoring window for reception of the control signal at the first wireless device, where transmission of the control signal may be during the monitoring window.

In some examples of the method, second wireless devices, and non-transitory computer-readable medium described herein, the monitoring window includes a symbol or a slot or a mini-slot boundary.

Some examples of the method, second wireless devices, and non-transitory computer-readable medium described herein may further include operations, features, means, or instructions for participating in communication of one or more second control signals that configure a length of the control signal, a quantity of repetitions of the control signal, or both.

In some examples of the method, second wireless devices, and non-transitory computer-readable medium described herein, the length of the control signal, the quantity of repetitions of the control signal, or both, may be based on a distance between the first wireless device and the second wireless device, a signal isolation capability of the first wireless device, a self-interference measurement associated with the first wireless device, or any combination thereof.

In some examples of the method, second wireless devices, and non-transitory computer-readable medium described herein, the one or more second control signals include a broadcast message broadcast by the first wireless device, an initial connection message received from the first wireless device, a periodic control message received from the first wireless device, a response message received from the first wireless device responsive to transmission of the control signal, or any combination thereof.

In some examples of the method, second wireless devices, and non-transitory computer-readable medium described herein, determining that the operational mode of the first wireless device may be the receive mode may include operations, features, means, or instructions for receiving a termination signal from the first wireless device based on transmission of the control signal, where the termination signal indicates a termination of transmission at the first wireless device of the first signal.

In some examples of the method, second wireless devices, and non-transitory computer-readable medium described herein, transmission of the priority signal may be based on reception of the termination signal.

Some examples of the method, second wireless devices, and non-transitory computer-readable medium described herein may further include operations, features, means, or instructions for determining that the operational mode of the first wireless device may be the receive mode may be based on an application time window after transmission of the control signal.

In some examples of the method, second wireless devices, and non-transitory computer-readable medium described herein, determining that the operational mode of the first wireless device may be the receive mode may include operations, features, means, or instructions for detecting a reduction in received energy from the first wireless device via a channel for receiving the first signal.

In some examples of the method, second wireless devices, and non-transitory computer-readable medium described herein, at least one of the first signal, the control signal, or the priority signal may be part of a V2X communication, a sidelink communication, a network access communication, or any combination thereof.

### BRIEF DESCRIPTION OF THE DRAWINGS

FIG. 1 shows an example of a wireless communications system that supports techniques for rapid communication of priority signaling in accordance with one or more aspects of the present disclosure.

FIG. 2 shows an example of a wireless communications system that supports techniques for rapid communication of priority signaling in accordance with one or more aspects of the present disclosure.

FIG. 3 shows an example of a process flow that supports techniques for rapid communication of priority signaling in accordance with one or more aspects of the present disclosure.

FIGS. 4 and 5 show block diagrams of devices that support techniques for rapid communication of priority signaling in accordance with one or more aspects of the present disclosure.

FIG. 6 shows a block diagram of a communications manager that supports techniques for rapid communication of priority signaling in accordance with one or more aspects of the present disclosure.

FIG. 7 shows a diagram of a system including a device that supports techniques for rapid communication of priority signaling in accordance with one or more aspects of the present disclosure.

FIGS. 8 and 9 show flowcharts illustrating methods that support techniques for rapid communication of priority signaling in accordance with one or more aspects of the present disclosure.

### DETAILED DESCRIPTION

In some wireless communications systems, user equipments (UEs) (e.g., vehicle-to-everything (V2X) devices, sidelink devices) may communicate without a network entity (e.g., base station) to coordinate aspects of the communications. In some cases, the lack of coordination may delay communication of priority signals (e.g., urgent messages) between the UEs. For example, a first UE may transmit a large amount of signaling (e.g., a large payload of data) to a second UE, and the second UE may have a priority signal to transmit to the first UE. However, the second UE may not be capable of transmitting the priority signal while receiving the large payload from the first UE (for example, the first UE may be operating in a half-duplex (HD) mode), and (e.g., due to the lack of network entity coordination) a time may not be scheduled for the second UE to transmit the priority signaling. Thus, the priority signaling may be delayed. In some cases, this delay may be alleviated by the first UE operating in a full duplex (FD) mode, and thus receiving the priority signal while transmitting the large amount of signaling (e.g., either in a single frequency or in separate subbands). However, operating in the FD mode may lead to self-interference for the first UE due to, for example, signal leakage within the first UE, signal reflection or signal clutter in the environment, or other factors. Self-interference may cause a high signal-to-interference-and-noise ratio (SINR) at the first UE, degrading the communications and increasing the difficulty to reliably receive the priority signal.

According to techniques described herein, a first UE (e.g., V2X UE, sidelink UE) may operate in a FD mode, and may receive a control signal associated with a low data rate from a second UE while concurrently transmitting a signal to a third UE, such that the control signal may be received at the first UE according to a reduced detection threshold (e.g., a reduced SINR, reduced compared to a regular or legacy detection threshold). The second and third UEs may be the same UE or may be different UEs, and the control signal may indicate that the second UE has an urgent message to send to the first UE. In some cases, the control signal may be a pre-configured (e.g., known) signal (e.g., waveform, sequence, reference signal) that is common to one or more UEs including the first, second, and third UEs. In other cases, the control signal may be of a set of signals, where each signal of the set of signals corresponds to a UE of a set of UEs (e.g., including the first, second, and third UEs), such that the first UE may identify a transmitter of the control signal based on the control signal.

Additionally, or alternatively, the first UE may communicate additional control signaling (e.g., with the second UE, the third UE, or both) configuring various aspects of the control signal. For example, the additional control signaling may configure a monitoring window for the first UE to receive the control signal, a length or duration of the control signal, a quantity of repetitions (e.g., repetition factor) of the control signal, or any combination thereof. The various aspects of the control signal may be configured based on a distance between the first UE and the second UE, a signal isolation capability of the first UE, self-interference associated with the first UE, or any combination thereof.

Additionally, or alternatively, the first UE may transition from operating in the FD mode to operating in a receive mode (e.g., to receive the priority signal) based on receiving the control signal. In some cases, the second UE may transmit the priority signal based on determining that the first UE transitioned to operating in the receive mode. For example, the second UE may detect a reduced received power from the first UE via a channel associated with the signal, refrain from transmitting the priority signal for an application time window, or receive a termination signal from the first UE to determine that the first UE is operating in the receive mode.

Aspects of the disclosure are initially described in the context of wireless communications systems. Aspects of the disclosure are also described in the context of process flow diagrams. Aspects of the disclosure are further illustrated by and described with reference to apparatus diagrams, system diagrams, and flowcharts that relate to techniques for rapid communication of priority signaling.

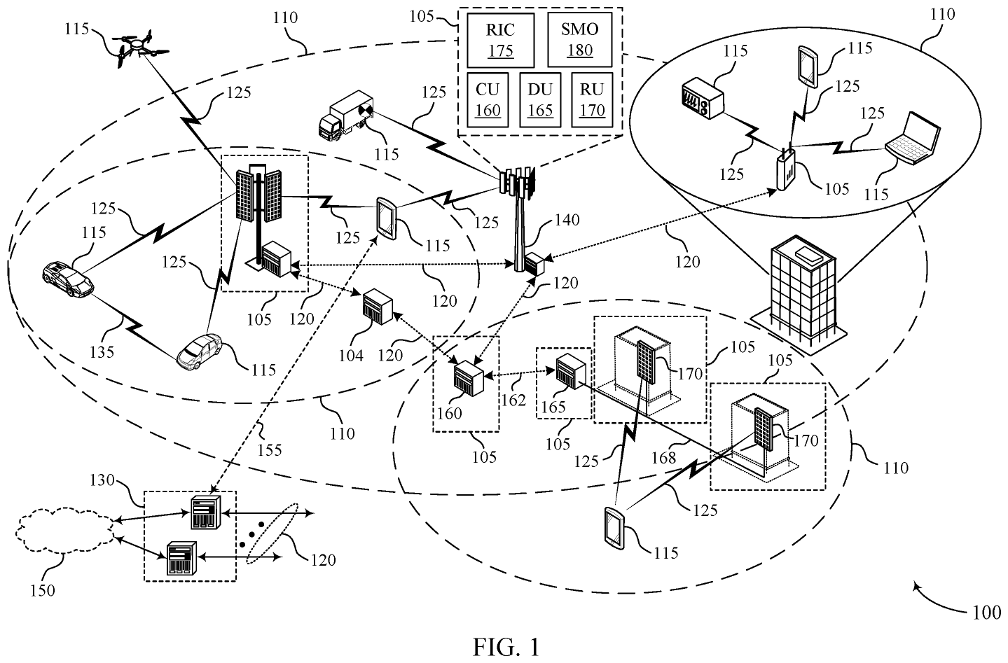

FIG. 1 shows an example of a wireless communications system 100 that supports techniques for rapid communication of priority signaling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for rapid communication of priority signaling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a first UE 115 (e.g., V2X UE, sidelink UE) may operate in a FD mode, and may receive a control signal associated with a low data rate from a second UE 115 while transmitting a signal to a third UE 115, such that the control signal may be received at the first UE 115 according to a reduced detection threshold (e.g., a reduced SINR, reduced compared to a regular or legacy detection threshold). The second and third UEs 115 may be the same UE 115 or may be different UEs 115, and the control signaling may indicate that the second UE 115 has an urgent message to send to the first UE 115. In some cases, the control signal may be a pre-configured (e.g., known) signal (e.g., waveform, sequence, reference signal) that is common to one or more UEs 115 including the first, second, and third UEs. In other cases, the control signal may be of a set of signals, where each signal of the set of signals corresponds to a UE 115 of a set of UEs (e.g., including the first UE 115, the second UE 115, and the third UE 115), such that the first UE 115 may identify a transmitter of the control signal based on the control signal.

Additionally, or alternatively, the first UE 115 may communicate control signaling (e.g., with the second UE 115, the third UE 115, or both) configuring various aspects of the control signal. For example, the control signaling may configure a monitoring window for the first UE 115 to receive the control signal, a length of the control signal, a quantity of repetitions (e.g., repetition factor) of the control signal, or any combination thereof. The various aspects of the control signal may be configured based on a distance between the first UE 115 and the second UE 115, a signal isolation capability of the first UE 115, self-interference associated with the first UE 115, or any combination thereof.

Additionally, or alternatively, the first UE 115 may transition from operating in the FD mode to operating in a receive mode (e.g., to receive the priority signal) based on receiving the control signal. In some cases, the second UE 115 may transmit the priority signal based on determining that the first UE 115 transitioned to operating in the receive mode. For example, the second UE 115 may detect a reduced received power from the first UE 115 via a channel associated with the signal, refrain from transmitting the priority signal for an application time window, or receive a termination signal from the first UE 115 to determine that the first UE 115 is operating in the receive mode.

Aspects of the disclosure are initially described in the context of wireless communications systems. Aspects of the disclosure are also described in the context of process flow diagrams. Aspects of the disclosure are further illustrated by and described with reference to apparatus diagrams, system diagrams, and flowcharts that relate to techniques for rapid communication of priority signaling.

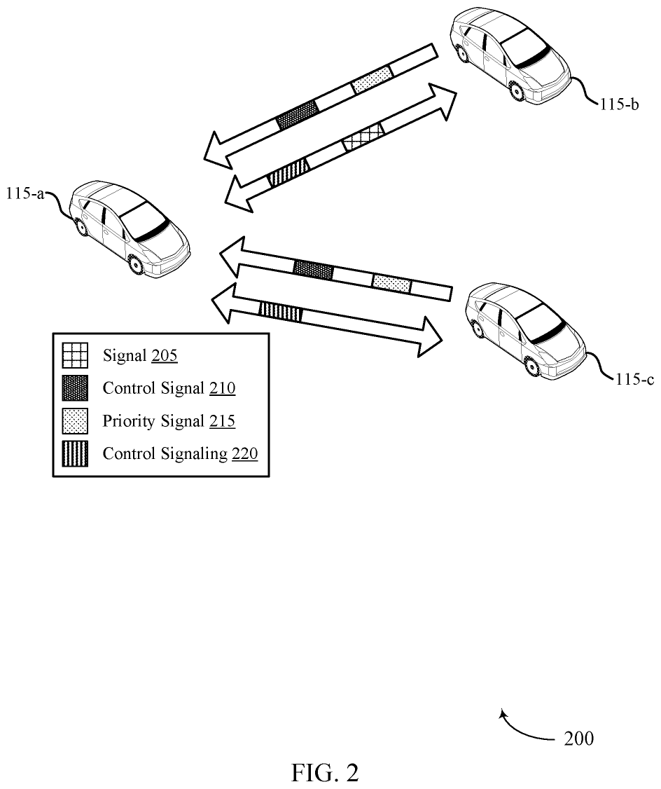

FIG. 2 shows an example of a wireless communications system 200 that supports techniques for rapid communication of priority signaling in accordance with one or more aspects of the present disclosure. In some cases, aspects of the wireless communications system 200 may implement or be implemented by aspects of FIG. 1. For example, the wireless communications system 200 may include UEs 115 (e.g., a UE 115-a, a UE 115-b, and a UE 115-c), which may be examples of the UEs 115 as described herein with respect to FIG. 1. In some aspects, the UE 115-a may receive a control signal 210 from at least one of the UE 115-b and the UE 115-c while transmitting a signal 205 and operating in a FD mode, where the control signal 210 may indicate that the transmitter of the control signal 210 has a priority signal 215 to transmit to the UE 115-a.

In some cases, a wireless communications system may support

enhancements for duplex operation (e.g., HD operations, FD operations) for NR TDD in unpaired radio communication frequency resources (e.g., spectrum). FD operations may include a wireless device concurrently operating in a receive mode and a transmit mode (e.g., being capable of receiving while transmitting, receiving wireless signaling while transmitting wireless signaling). In some cases, a network entity (e.g., base station, gNB) of the wireless communications system may support the enhancements for duplex operations, including FD operations. Additionally, or alternatively, a UE of the wireless communications system may support the enhancements for duplex operations, including HD operations. In some cases, the wireless communications system may support the HD and FD operations with no restrictions on frequency range. Additionally, or alternatively, the enhancements to duplex operation may include sub-band non-overlapping FD operations (e.g., FD operations including receiving operations in a first frequency range and transmitting in a second frequency range that is non-overlapping with the first frequency range), enhancements to dynamic (e.g., flexible) TDD, or both.

A wireless device (e.g., network entity) with FD capabilities (e.g., a FD network entity) may perform simultaneous transmission and reception on a same slot. In some cases, FD operations may include sub-band FD (SBFD) operations, which may be performed in a carrier (e.g., a single TDD carrier), or in multiple carriers (e.g., intra-band carrier aggregation based). SBFD operations may allow for simultaneous transmission and reception of downlink and uplink (e.g., respectively) at a device (e.g., a network entity) on a sub-band basis. For example, the device may transmit wireless signaling in a first one or more portions of a bandwidth of one or more component carriers (e.g., a single component carrier, carrier aggregated component carriers), and the device may simultaneously (e.g., in a same slot, in a same symbol) receive wireless signaling in a second one or more portions of the bandwidth of the one or more component carriers. Additionally, or alternatively, FD operations may include single frequency FD (SFFD) operations, where a wireless device may receive and transmit signaling using respective antenna elements via a same frequency and time resource.

In some cases, SBFD operations may be associated with one or more advantages for a wireless device. In one example, a wireless device implementing SBFD operations may experience an increased uplink duty cycle, which may reduce latency and improve uplink coverage by the wireless device. For example, SBFD operation may allow the wireless device to communicate (e.g., transmit, receive) uplink signals in an uplink sub-band during downlink slots (e.g., traditionally downlink slots, legacy downlink slots) or flexible slots, and to communicate downlink signals in downlink sub-bands during uplink slots (e.g., traditionally uplink slots, legacy uplink slots), which may reduce latency in switching from uplink to downlink signaling.

As another example, a wireless device implementing SBFD operations may experience enhanced system capacity (e.g., capable of communicating more information per time period), enhanced wireless communication resource utilization, and enhanced spectrum efficiency. In some cases, implementing SBFD operations may also allow for enhanced dynamic (e.g., flexible) uplink or downlink resource adaption at the wireless device according to uplink or downlink traffic conditions.

In some cases, a wireless device (e.g., a FD capable deice) may be equipped with FD capabilities, which may include SBFD capabilities, SFFD capabilities, or both. In some examples, the wireless device may experience self-interference due to the FD capabilities of the wireless device, which may include the wireless device experiencing interference in a received signal due to transmitted signaling from the wireless device. For example, self-interference may result from radio leakage within the wireless device, radio wave reflection (e.g., clutter) in an environment of the wireless device, or both. In some cases, an effect of the self-interference on the received signal (e.g., the quality of the received signal, the ability of the wireless device to decode the received signal) may depend on a detection threshold (e.g., a SINR threshold) for receiving signaling at the wireless device. In some cases, a method of reducing the detection threshold for receiving signaling in an SFFD or SBFD use case may be desired.

In some cases, a wireless communications system (e.g., a V2X system) may lack a centralized controlling entity (e.g., a network entity) to coordinate transmission and receptions amongst wireless devices in the wireless communications system. Additionally, or alternatively, the wireless communications system may experience a use case of mixed “best effort” traffic (e.g., signaling that is not sensitive to quality of service (QOS) metrics (e.g., latency, jitter, packet loss), traffic that is not guaranteed to be delivered or to meet quality standards) and priority traffic (e.g., urgent messages).

In some cases, HD operations may increase a latency of the wireless communications system. For example, a first wireless device (e.g., a UE, a V2X entity) of the wireless communications system may transmit a large amount of signaling (e.g., traffic) to a second wireless device of the wireless communications system, while the second wireless device or a third wireless device of the wireless communications system may identify priority signaling for the first wireless device. However, due to the lack of centralized controlling entity over the wireless devices, an arrival time of the priority signaling at the first wireless device may not be known to the first wireless device, and thus the first wireless device may not receive the priority signaling, or the priority signaling may be delayed by the large amount of signaling.

In some cases, the wireless devices of the wireless communications system may be HD capable devices, and thus the wireless devices may implement a HD operation in an attempt to reduce the latency in the described scenario. For example, the first wireless device may transmit signaling to the second wireless device for a first duration of time, and then may switch to a receive mode for a second duration of time to determine whether priority signaling arrives from the second wireless device or the third wireless device. Then, if no priority signaling arrives during the second duration, the first wireless device may switch to the transmit mode for another first duration of time repeat the described procedure. However, in such a HD operation, a length of the first duration of time may determine a latency of a delivery of the priority signaling to the first wireless device, while frequent switching between the transmit mode and the receive mode at the first wireless device may result in increased processing overhead. Thus, a FD operation for such a scenario may be desirable, where the detection threshold (e.g., SINR threshold) for receiving signaling in the FD operation may be lowered to reduce self-interference at the first wireless device.

According to techniques described herein, the UE 115-a may receive, during transmission of the signal 205 (e.g., best effort traffic), a control signal 210 that may indicate that a priority signal 215 is intended for the UE 115-a from the UE 115-b, the UE 115-c, or both. For example, the UE 115-a may transmit the signal 205 to the UE 115-b while the UE 115-a may be operating in a FD mode (e.g., in a simultaneous receive mode and transmit mode). While transmitting the signal 205, the UE 115-a may receive, from the UE 115-b, the UE 115-c, or both, the control signal 210, which may indicate that the UE 115-b, the UE 115-c, or both, respectively, have a priority signal 215 to transmit to the UE 115-a.

In some cases, the communication of the control signal 210, the priority signal 215, or both, may be based on control signaling 220. In some cases, the UE 115-a may communicate the control signaling 220 with the UE 115-b, the UE 115-c, or both, as regular (e.g., periodic) control signaling, as connection stage signaling, as broadcasted signaling, or in response to receiving the control signal 210. In some cases, the control signaling 220 may include one or more control messages.

As described herein, while the UE 115-a is transmitting the signal 205, the UE 115-a may receive the control signal 210. For example, the UE 115-a may utilize an SFFD or SBFD capability (e.g., radio) to monitor for a low data rate signal from the UE 115-b, the UE 115-c, or both. In some cases, the control signal 210 may be of a low data rate, such that the UE 115-a may receive the control signal 210 according to a reduced detection threshold for receiving signaling at the UE 115-a, which may reduce self-interference at the UE 115-a due to transmitting the signal 205 while receiving the control signal 210. In this way, the detection threshold (e.g., a SINR threshold) for the control signal 210 may be low at the UE 115-a.

In some cases, the control signal 210 may indicate that the device which transmitted the control signal 210 will transmit (e.g., has, identified, is aware of) the priority signal 215 for the UE 115-a. For example, the control signal 210 may not carry additional information related to the priority signal 215 (e.g., such as that related to a contents of the priority signal 215). Additionally, or alternatively, the control signal 210 may indicate one or more parameters associated with the priority signal, such as a size, a transmit time, or one or more other wireless communication parameters associated with the priority signal 215.

In some cases, one or more aspects of the control signal 210 may be known (e.g., via configuration from a network entity, via pre-configuration) to the UE 115-a, the UE 115-b, the UE 115-c, or any combination thereof. For example, the control signal 210 may include a waveform, a sequence, or a reference signal that is known at the UEs 115 (e.g., configured to the UEs 115), and the UE 115-a may monitor (e.g., while transmitting the signal 205) to detect the presence of a control signal that includes the waveform, the sequence, or the reference signal.

Additionally, or alternatively, the control signal 210 may include a waveform, a sequence, or a reference signal of a set of waveforms, a set of sequences, or a set of reference signals known to the UEs 115. For example, a network entity 105 (e.g., a DU, an CU) may configure at least one such waveform, one such sequence, or one such reference signal of the set of waveforms, the set of sequences, or the set of waveforms, respectively, as corresponding to the UE 115-a, the UE 115-b, and the UE 115-c, respectively. In such an example, the UE 115-a may determine which UE 115 (e.g., of the UE 115-b and the UE 115-c) may transmit the priority signal 215 to the UE 115-a based on the waveform, sequence, or reference signal included in the control signal 210. Additionally, or alternatively, the network entity 105 (e.g., the DU, the CU) may configure the UE 115-a, the UE 115-b, the UE 115-c, or any combination thereof with the set of waveforms, the set of sequences, or the set of reference signals (e.g., or any combination thereof) for communicating according to the techniques described herein.

In some cases, the control signaling 220 may configure aspects of communication of the control signal 210 between the UEs 115. For example, the UE 115-b, the UE 115-c, or both, may transmit the control signal 210 (e.g., and the UE 115-a may receive the control signal 210) during a monitoring time window (e.g., at a time instant) that may be configured by the UEs 115 based on the control signaling 220. For example, the control signaling 220 may indicate the monitoring time window (e.g., or one or more time resources) for receiving the control signal 210 at the UE 115-a to a receiving UE 115. In some cases, the monitoring time window may include a symbol, a slot, a slot boundary, a mini-slot boundary, or any combination thereof.

Additionally, or alternatively, the control signal 210 may be of a length based on the control signaling 220. For example, the length (e.g., a time duration, a quantity of slots, a quantity of symbols) of the control signal 210 (e.g., the waveform, the sequence, or the reference signal included in the control signal 210) may be configurable, and may vary depending on the control signaling 220. For example, if self-interference at the UE 115-a is severe (e.g., satisfies a threshold self-interference), the UE 115-a may transmit the control signaling to the UE 115-b, the UE 115-c, or both, where the control signaling 220 may indicate to the UE 115-b, the UE 115-c, or both, to increase the length of the control signal 210 to assist with signal detection at the UE 115-a. Additionally, or alternatively, the length of the control signal 210 may be a based on a signaling isolation capability of the UE 115-a (e.g., the length may be a static parameter, where greater signaling isolation capability is associated with a shorter length), or the length of the control signal 210 may vary dynamically based on a measurement of self-interference at the UE 115-a.

Additionally, or alternatively, the length of the control signal 210 may depend on a distance between the UEs 115. For example, if the UE 115-b is farther from the UE 115-a than the UE 115-c is from the UE 115-a, the UE 115-b may be configured (e.g., via the control signaling 220 from the UE 115-a, via a network entity 105) to transmit the control signal 210 according to a greater length than the UE 115-c, which may assist with signal detection at the UE 115-a.

Additionally, or alternatively, the control signaling 220 may configure a repetition factor (e.g., a quantity of repetitions, a quantity of instances) associated with the control signal 210. For example (e.g., similar to the length of the control signal 210), the repetition factor may be based on a signaling isolation capability of the UE 115-a (e.g., where greater signaling isolation capability is associated with a smaller repetition factor), or the repetition factor may vary dynamically based on the measurement of self-interference at the UE 115-a.

Additionally, or alternatively, the repetition factor of the control signal 210 may be based on a distance between the UEs 115. For example, if the UE 115-b is farther from the UE 115-a than the UE 115-c is from the UE 115-a, the UE 115-b may be configured (e.g., via the control signaling 220 from the UE 115-a, via a network entity 105) to transmit the control signal 210 according to a larger repetition factor (e.g., with more repetitions) than the UE 115-c, which may assist with signal detection at the UE 115-a.

In some cases, the UE 115-a may perform one or more actions in response to receiving the control signal 210. For example, the UE 115-a may stop transmitting the signal 205 after (e.g., immediately after, upon) receiving the control signal 210. Additionally, or alternatively, the UE 115-a may switch to a receive mode, in preparation to receive the priority signal 215. In some cases, the UE 115-a may switch to the receive mode from the FD mode based on the measurement of the self-interference, the data rate of the priority signal 215, or both. Additionally, or alternatively, the UE 115-a may transmit a termination signal (e.g., an “ENDING” signal) in response to receiving the control signal 210, where the termination signal may indicate to the receiver to stop the reception chain of the signal 205, to transmit the priority signal, or both.

After transmitting the control signal 210 to the UE 115-a, the UEs 115-b, the UE 115-c, or both, may perform one or more actions. As a first example, the UE 115-b, the UE 115-c, or both, may autonomously transmit the priority signal after a first application time window (e.g., a time duration, a configured time duration) following the transmission of the control signal 210. For example, one or more of the UEs 115 may receive control signaling from a network entity 105 configuring the first application time window.

As another example, the UE 115-b, the UE 115-c, or both, may monitor a channel between the respective UE 115 and the UE 115-a for a drop in received energy from the UE 115-a. For example, if UE 115-b transmits the control signal 210 to the UE 115-a, the UE 115-b may monitor the channel based on receiving the signal 205 before or during transmission of the control signal 210. If UE 115-c transmits the control signal 210 to the UE 115-a, the UE 115-c may monitor the channel based on a distance between the UE 115-c and the UE 115-a (e.g., since the UE 115-c was not receiving the signal 205 before or during transmission of the control signal 210). For example, if the UE 115-c determines a distance between the UE 115-a and the UE 115-c to be less than a distance threshold, the UE 115-c may monitor the channel for the drop in received power from the UE 115-a. Additionally, or alternatively, the UE 115-b, the UE 115-c, or both, may monitor the channel for a second application window, where a network entity 105 may configure the UEs 115 with the second application time window.

Based on monitoring the channel, the UE 115-b, the UE 115-c, or both, may detect a drop in received energy from the UE 115-a (e.g., based on the UE 115-a stopping the transmission of the signal 205). In some cases, based on detecting the drop in received energy from the UE 115-a, the UE 115-b, the UE 115-c, or both, may determine that the UE 115-a has switched to a receive mode, and may transmit the priority signal 215 to the UE 115-a.

As yet another example, the UE 115-b, the UE 115-c, or both, may receive the termination signal from the UE 115-a based on transmitting the control signal 210 to the UE 115-a. In some cases, based on receiving the termination signal, the UE 115-b, the UE 115-c, or both, may determine that the UE 115-a has switched to a receive mode, and may transmit the priority signal 215 to the UE 115-a.

In some cases, the techniques described herein may be utilized in a V2X (e.g., cellular-V2X (C-V2X)) wireless communications system. However, the techniques described herein (e.g., communication the control signal 210, the priority signal 215, the control signaling 220) may be extended beyond V2X wireless communications systems. For example, the techniques described herein may extend to sidelink communications (e.g., sidelink FD scenarios), network access communications (e.g., Uu link FD scenarios), or any other known wireless communication scenario.

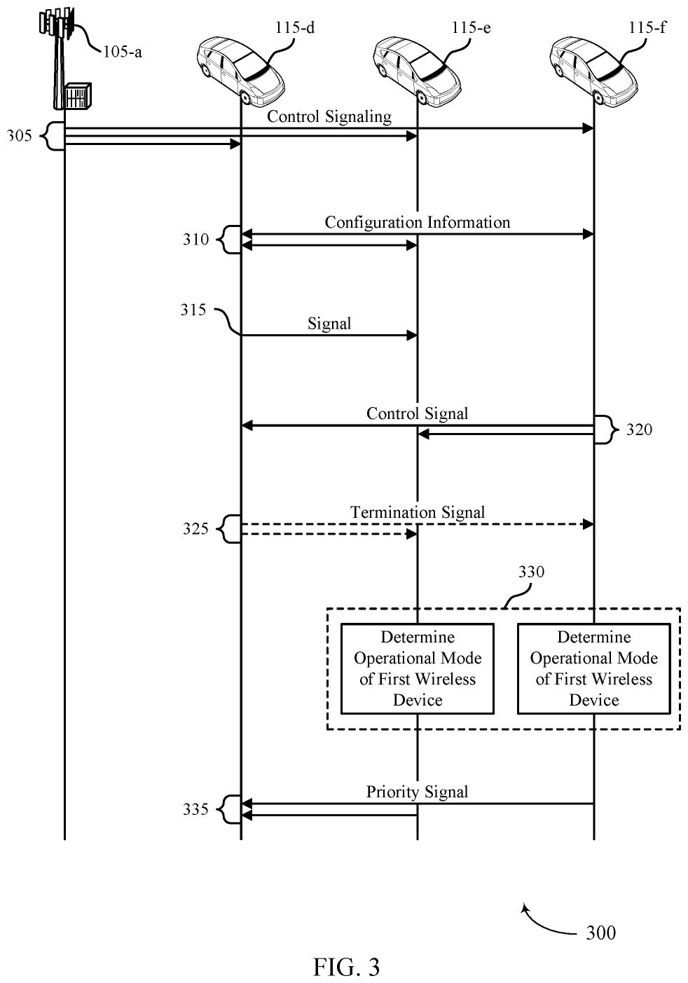

FIG. 3 shows an example of a process flow 300 that supports techniques for rapid communication of priority signaling in accordance with one or more aspects of the present disclosure. In some cases, aspects of the process flow 300 may implement or be implemented by aspects of FIGS. 1 and 2. For example, the process flow 300 may include a network entity 105-a and UEs 115 (e.g., a UE 115-d, a UE 115-e, and a UE 115-f) which may be examples of the network entities 105 and the UEs 115, respectively, as described herein with respect to FIGS. 1 and 2. In some cases, the UE 115-d may perform techniques for rapid communication of priority signaling with the UEs 115-e and 115-f according to aspects of the process flow 300.

In the following description of process flow 300, the operations may be performed in a different order than the order shown, or other operations may be added or removed from the process flow 300. For example, some operations may also be left out of process flow 300, may be performed in different orders or at different times, or other operations may be added to process flow 300. Although the UEs 115-d, 115-e, and 115-f, and the network entity 105-a are shown performing the operations of process flow 300, some aspects of some operations may also be performed by one or more other wireless devices or network devices.

Additionally, or alternatively, one or more operations of the process flow 300 may occur between two or more of the UEs 115 and the network entity 105-a of FIG. 3. For example, at 305, the network entity 105-a may transmit a control signal to the UE 115-d, the UE 115-e, the UE 115-f, or any combination thereof. As another example, at 320, the UE 115-d may receive a control signal from the UE 115-e, the UE 115-f, or both. A similar concept may be true for each aspect of the process flow 300.

At 305, the UEs 115 (e.g., one or more of the UE 115-d, the UE 115-e, and the UE 115-f) may receive the control signaling from the network entity 105-a, where the control signaling may indicate that a waveform, a sequence, or a reference signal may be associated with indication of priority signaling from a corresponding UE 115 of a set of UEs 115 (e.g., including the UE 115-d, the UE 115-e, the UE 115-f, or any combination thereof). That is, the control signaling may identify one or more waveforms, sequences, or reference signals, and the control signaling may indicate that the one or more waveforms, sequences, or reference signals may be included in a control signal to indicate to a first of the UEs 115 (e.g., the UE 115-d) that a second of the UEs 115 (e.g., UE 115-e, UE 115-f) has priority signaling (e.g., an urgent message, important data) for the first of the UEs 115 (e.g., scheduled for the first of the UEs 115, addressed to the first of the UEs 115, corresponding to the first of the UEs 115). Additionally, each of the one or more waveforms, sequences, or reference signals may be common amongst the set of UEs 115, or may correspond to a respective UE 115 (e.g., may identify the respective UE 115 as the transmitter of the control signal to the receiver of the control signal).

At 310, the UEs 115 may participate in communication of one or more control signals that configure aspects of communicating the control signal. For example, the one or more control signals may configure a monitoring window (e.g., a monitoring time duration) for reception of the control signal at the UE 115-d. In some cases, the monitoring window may include a symbol, a slot, a mini-slot boundary, a slot-boundary, or any other unit of wireless communication time resources.

Additionally, or alternatively, the one or more control signals may configure a length of the control signal, a quantity of repetitions of the control signal, or both. In some cases, the length of the control signal, the quantity of repetitions of the control signal, or both, for reception of the control signal at the UE 115-d, may be based on one or more factors (e.g., as described herein with respect to FIG. 2). For example, the one or more factors may include a distance between the UE 115-d and a transmitter (e.g., source) of the control signal (e.g., either UE 115-e or UE 115-f), a signal isolation capability of the UE 115-d, a self-interference measurement associated with the UE 115-d, or any combination thereof.

The UEs 115 may communicate the one or more control signals via various messages. For example, the one or more control signals may include a broadcast message, which may be broadcast by the UE 115-d. The one or more control messages may also include an initial connection message transmitted by the UE 115-d to the UE 115-e, the UE 115-f, or both (e.g., a source (e.g., potential source) of the control signal). Additionally, or alternatively, the one or more control signals may include a periodic control message transmitted by the UE 115-d, a response message transmitted by the UE 115-d responsive to reception of the control signal from one or the UEs 115, or any combination thereof.

At 315, the UE 115-d may transmit a first signal to the UE 115-e during operation of the UE 115-d in a FD mode. For example, operation in the FD mode may include a capability to simultaneously operate in a transmit mode and a receive mode. In some cases, the FD mode may be a sub-band FD mode.

At 320, the UE 115-d may receive (e.g., detect), during transmission of the first signal, the control signal that is indicative that a priority signal is intended for the UE 115-d. For example, the UE 115-d may receive (e.g., process, decode, perform a receive chain for) the control signal, or the UE 115-d may detect (e.g., determine to have been transmitted, but do not process, decode, or perform a receive chain for) the control signal. In some cases, the UE 115-d may receive the control signal from the UE 115-e, the UE 115-f, or both. In some cases, the control signal may be the waveform, the sequence, or the reference signal described at 305. For example, the waveform, the sequence, or the reference signal may, upon reception at the UE 115-d, be indicative that the priority signal is intended for the UE 115-d. In a case where the UE 115-d receives the control signal from the UE 115-e, the UE 115-e may transmit the control signal to the UE 115-d based on receiving the first signal and having the priority signal to transmit to the UE 115-d while receiving the first signal.

In some cases, the waveform, the sequence, or the reference signal of the control signal may each be part of a set of waveforms, a set of sequences, or a set of reference signals, respectively. For example, each of the set of waveforms, the set of sequences, or the set of reference signals may be associated with indication of priority signaling. In some cases, each waveform of the set of waveforms, each sequence of the set of sequences, or each reference signal of the set of reference signals, may correspond to a UE 115 of a set of UEs 115 (e.g., including the UE 115-d, the UE 115-e, the UE 115-f, or any combination thereof). Thus, after receiving the control signal, the UE 115-d may determine a source UE 115 of the control signal based on the waveform, sequence, or reference signal of the control signal.

In some cases, reception of the control signal at the UE 115-d during transmission of the first signal may be facilitated by the control signal having a data rate that satisfies (e.g., is less than) a data rate threshold. For example, reception at the UE 115-d at a first data rate (e.g., of a signal having the first data rate) that satisfies the data rate threshold may be associated with a first detection threshold at the UE 115-d, and reception at the UE 115-d at a second data rate that does not satisfy (e.g., is greater than) the data rate threshold may be associated with a second detection threshold that is greater than the first detection threshold. In some cases, the first detection threshold, the second detection threshold, or both, may be signal-to-interference-plus-noise ratio (SINR) thresholds.

At 325, the UE 115-d may transmit a termination signal to the UE 115-e, the UE 115-f, or both, based at least in part on reception of the control signal. For example, the termination signal may indicate a termination of transmission of the first signal. In some cases, the UE 115-d may transmit the termination signal to the UE 115-e based on transmitting the first signal to the UE 115-e and receiving the control signal from the UE 115-e. Additionally, or alternatively, the UE 115-d may not transmit the termination signal to the UE 115-f based on receiving the control signal because the UE 115-d did not transmit the first signal to the UE 115-f.

At 330, at least a UE 115 of the UEs 115-e and the UE 115-f may determine whether (e.g., that) the operational mode of the UE 115-d is the receive mode based on transmitting the control signal (e.g., the UE 115 that transmits the control signal may determine whether the operational mode of the UE 115-d is the receive mode). In some cases, the UE 115 may make the determination based on an application time window after transmission of the control signal. Additionally, or alternatively, the UE 115 may make the determination based on detecting a reduction in received energy from the UE 115-d via a channel for receiving the first signal. For example, the UE 115 may monitor a received energy from the UE 115-d for the application time window after transmitting the control signal and, after detecting a reduction in received energy from the UE 115-d that is greater than an energy reduction threshold, the UE 115 may determine that the operation mode of the UE 115-d is the receive mode. Additionally, or alternatively, the UE 115 may determine that the operational mode of the UE 115-d is the receive mode based on receiving the termination signal from the UE 115-d.

At 335, the UE 115-d may receive the priority signal from the transmitter (e.g., source) of the control signal, and may receive the priority signal after a transition of the UE 115-d from operation in the FD mode to operation in the receive mode. In some cases, the transition may be based at least in part on reception of the control signal. In some cases, reception of the priority signal may be based at least in part on transmission of the termination signal, and the UE 115 may transmit the priority signal to the UE 115-d based on determining that the operational mode of the UE 115-d is the receive mode. Additionally, or alternatively, the UE 115 may transmit the priority signal based on reception of the termination signal from the UE 115-d.

The signals described herein (e.g., control signaling, the one or more control signals, the first signal, the control signal, the termination signal, the priority signal) may be of one or more types of signaling. For example, at least one of the first signal, the control signal, or the priority signal may be a part of a V2X communication, a sidelink communication, a network access communication, or any combination thereof. In some cases, any of the signaling after the first signal (e.g., the control signal, the priority control signal) may be from or otherwise indicate whether the signal is transmitted by a UE 115 that received the first signal or by a different UE 115.

In this way, the UEs 115 may communicate according to techniques for rapid communication of priority signaling as described herein. In some cases, the UEs 115 may experience less latency in communicating priority signaling based on the techniques described herein.

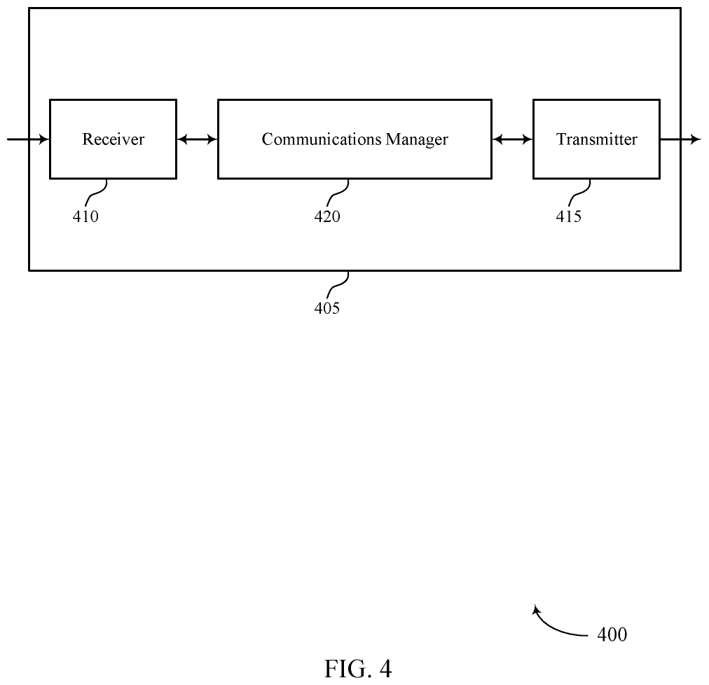

FIG. 4 shows a block diagram 400 of a device 405 that supports techniques for rapid communication of priority signaling in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for rapid communication of priority signaling).

Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for rapid communication of priority signaling). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for rapid communication of priority signaling as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a first signal from the first wireless device during operation of the first wireless device in a FD mode, where operation in the FD mode includes a capability to simultaneously operate in a transmit mode and a receive mode. The communications manager 420 is capable of, configured to, or operable to support a means for receiving, during transmission of the first signal, a control signal that is indicative that a priority signal is intended for the first wireless device. The communications manager 420 is capable of, configured to, or operable to support a means for receiving the priority signal after a transition of the first wireless device from operation in the FD mode to operation in the receive mode, where the transition is based on reception of the control signal.

Additionally, or alternatively, the communications manager 420 may support wireless communications in accordance with examples as disclosed herein. For example, the communications manager 420 is capable of, configured to, or operable to support a means for transmitting a control signal to a first wireless device during operation of the first wireless device in a FD mode and during transmission, by the first wireless device, of a first signal, where the control signal is indicative that a priority signal is intended for the first wireless device. The communications manager 420 is capable of, configured to, or operable to support a means for transmitting the priority signal to the first wireless device based on determining that an operational mode of the first wireless device is a receive mode based on transmission of the control signal.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources. For example, a UE 115 implementing the techniques described herein may utilize more resources for priority signaling, thus more efficiently utilizing the communication resources.

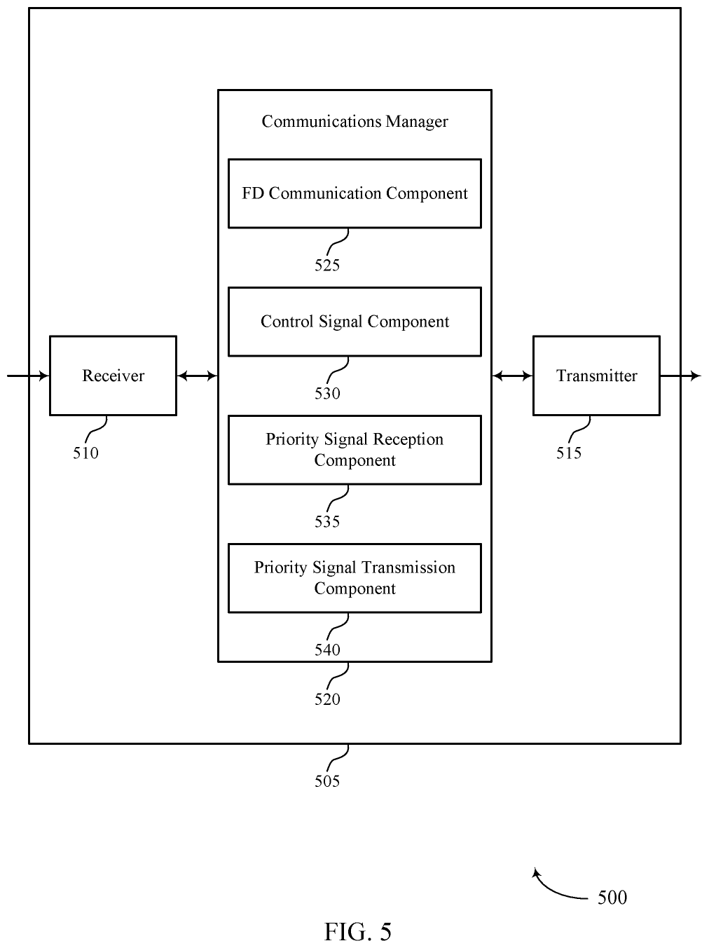

FIG. 5 shows a block diagram 500 of a device 505 that supports techniques for rapid communication of priority signaling in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for rapid communication of priority signaling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for rapid communication of priority signaling). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for rapid communication of priority signaling as described herein. For example, the communications manager 520 may include an FD communication component 525, a control signal component 530, a priority signal reception component 535, a priority signal transmission component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The FD communication component 525 is capable of, configured to, or operable to support a means for transmitting a first signal from the first wireless device during operation of the first wireless device in a FD mode, where operation in the FD mode includes a capability to simultaneously operate in a transmit mode and a receive mode. The control signal component 530 is capable of, configured to, or operable to support a means for receiving, during transmission of the first signal, a control signal that is indicative that a priority signal is intended for the first wireless device. The priority signal reception component 535 is capable of, configured to, or operable to support a means for receiving the priority signal after a transition of the first wireless device from operation in the FD mode to operation in the receive mode, where the transition is based on reception of the control signal.

Additionally, or alternatively, the communications manager 520 may support wireless communications in accordance with examples as disclosed herein. The control signal component 530 is capable of, configured to, or operable to support a means for transmitting a control signal to a first wireless device during operation of the first wireless device in a FD mode and during transmission, by the first wireless device, of a first signal, where the control signal is indicative that a priority signal is intended for the first wireless device. The priority signal transmission component 540 is capable of, configured to, or operable to support a means for transmitting the priority signal to the first wireless device based on determining that an operational mode of the first wireless device is a receive mode based on transmission of the control signal.

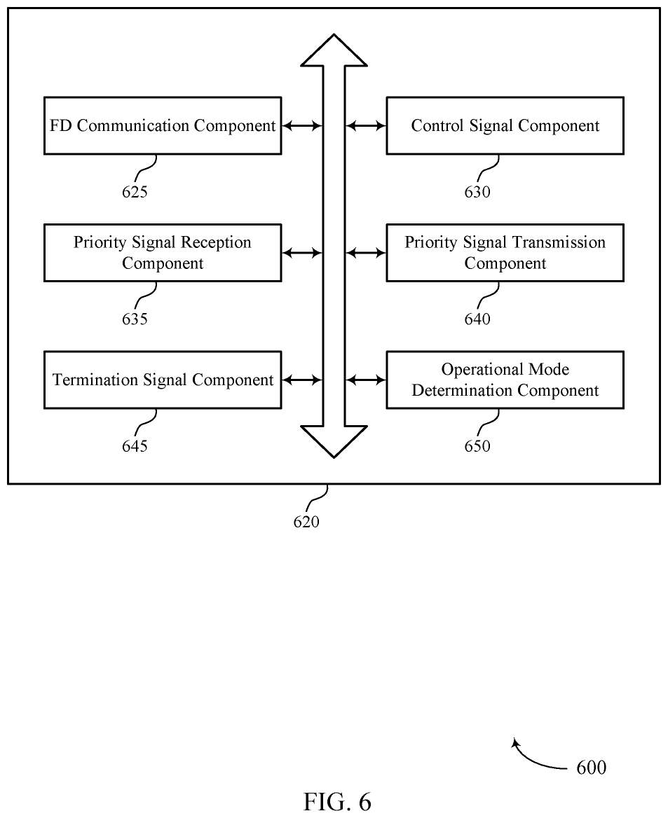

FIG. 6 shows a block diagram 600 of a communications manager 620 that supports techniques for rapid communication of priority signaling in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for rapid communication of priority signaling as described herein. For example, the communications manager 620 may include an FD communication component 625, a control signal component 630, a priority signal reception component 635, a priority signal transmission component 640, a termination signal component 645, an operational mode determination component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The FD communication component 625 is capable of, configured to, or operable to support a means for transmitting a first signal from the first wireless device during operation of the first wireless device in a FD mode, where operation in the FD mode includes a capability to simultaneously operate in a transmit mode and a receive mode. The control signal component 630 is capable of, configured to, or operable to support a means for receiving, during transmission of the first signal, a control signal that is indicative that a priority signal is intended for the first wireless device. The priority signal reception component 635 is capable of, configured to, or operable to support a means for receiving the priority signal after a transition of the first wireless device from operation in the FD mode to operation in the receive mode, where the transition is based on reception of the control signal.

In some examples, the control signal is a waveform, a sequence, or a reference signal that, upon reception, is indicative that the priority signal is intended for the first wireless device.

In some examples, the waveform, the sequence, or the reference signal are each part of a set of waveforms, a set of sequences, or a set of reference signals, respectively. In some examples, each of the set of waveforms, the set of sequences, or the set of reference signals is associated with indication of priority signaling.

In some examples, the control signal component 630 is capable of, configured to, or operable to support a means for receiving a second control signal that indicates that the waveform, the sequence, or the reference signal is associated with indication of priority signaling on a per device basis.

In some examples, reception of the control signal during transmission of the first signal is facilitated by the control signal having a data rate that is less than a data rate threshold. In some examples, reception at the first wireless device at a first data rate that is less than the data rate threshold is associated with a first detection threshold at the first wireless device. In some examples, reception at the first wireless device at a second data rate that is greater than the data rate threshold is associated with a second detection threshold that is greater than the first detection threshold.

In some examples, the first detection threshold is a signal-to-interference-plus-noise ratio (SINR) threshold.

In some examples, the control signal component 630 is capable of, configured to, or operable to support a means for participating in communication of one or more second control signals that configure a monitoring window for reception of the control signal at the first wireless device.

In some examples, the monitoring window includes a symbol or a slot or a mini-slot boundary.

In some examples, the control signal component 630 is capable of, configured to, or operable to support a means for participating in communication of one or more second control signals that configure a length of the control signal, a quantity of repetitions of the control signal, or both.

In some examples, the length of the control signal, the quantity of repetitions of the control signal, or both, are based on a distance between the first wireless device and a source of the control signal, a signal isolation capability of the first wireless device, a self-interference measurement associated with the first wireless device, or any combination thereof.

In some examples, the one or more second control signals include a broadcast message broadcast by the first wireless device, an initial connection message transmitted by the first wireless device to a source of the control signal, a periodic control message transmitted by the first wireless device, a response message transmitted by the first wireless device responsive to reception of the control signal, or any combination thereof.

In some examples, the termination signal component 645 is capable of, configured to, or operable to support a means for transmitting a termination signal based on reception of the control signal, where the termination signal indicates a termination of transmission of the first signal.

In some examples, reception of the priority signal is based on transmission of the termination signal.

In some examples, at least one of the first signal, the control signal, or the priority signal is a part of a vehicle-to-everything communication, a sidelink communication, a network access communication, or any combination thereof.

Additionally, or alternatively, the communications manager 620 may support wireless communications in accordance with examples as disclosed herein. In some examples, the control signal component 630 is capable of, configured to, or operable to support a means for transmitting a control signal to a first wireless device during operation of the first wireless device in a FD mode and during transmission, by the first wireless device, of a first signal, where the control signal is indicative that a priority signal is intended for the first wireless device. The priority signal transmission component 640 is capable of, configured to, or operable to support a means for transmitting the priority signal to the first wireless device based on determining that an operational mode of the first wireless device is a receive mode based on transmission of the control signal.

In some examples, the FD communication component 625 is capable of, configured to, or operable to support a means for receiving the first signal from the first wireless device, where transmitting the control signal is based on reception of the first signal.

In some examples, the control signal is a waveform, a sequence, or a reference signal that is indicative to a receiver that the priority signal is intended for the first wireless device.

In some examples, the waveform, the sequence, or the reference signal are each part of a set of waveforms, a set of sequences, or a set of reference signals, respectively. In some examples, each of the set of waveforms, the set of sequences, or the set of reference signals is associated with indication of priority signaling.

In some examples, the control signal component 630 is capable of, configured to, or operable to support a means for receiving a second control signal that indicates that the waveform, the sequence, or the reference signal is associated with indication of priority signaling for the first wireless device corresponding to the second wireless device.

In some examples, the control signal has a data rate that is less than a data rate threshold.

In some examples, the control signal component 630 is capable of, configured to, or operable to support a means for participating in communication of one or more second control signals that configure a monitoring window for reception of the control signal at the first wireless device, where transmission of the control signal is during the monitoring window.

In some examples, the monitoring window includes a symbol or a slot or a mini-slot boundary.

In some examples, the control signal component 630 is capable of, configured to, or operable to support a means for participating in communication of one or more second control signals that configure a length of the control signal, a quantity of repetitions of the control signal, or both.

In some examples, the length of the control signal, the quantity of repetitions of the control signal, or both, are based on a distance between the first wireless device and the second wireless device, a signal isolation capability of the first wireless device, a self-interference measurement associated with the first wireless device, or any combination thereof.

In some examples, the one or more second control signals include a broadcast message broadcast by the first wireless device, an initial connection message received from the first wireless device, a periodic control message received from the first wireless device, a response message received from the first wireless device responsive to transmission of the control signal, or any combination thereof.

In some examples, to support determining that the operational mode of the first wireless device is the receive mode, the operational mode determination component 650 is capable of, configured to, or operable to support a means for receiving a termination signal from the first wireless device based on transmission of the control signal, where the termination signal indicates a termination of transmission at the first wireless device of the first signal.

In some examples, transmission of the priority signal is based on reception of the termination signal.

In some examples, determining that the operational mode of the first wireless device is the receive mode is based on an application time window after transmission of the control signal.

In some examples, to support determining that the operational mode of the first wireless device is the receive mode, the operational mode determination component 650 is capable of, configured to, or operable to support a means for detecting a reduction in received energy from the first wireless device via a channel for receiving the first signal.

In some examples, at least one of the first signal, the control signal, or the priority signal is part of a vehicle-to-everything communication, a sidelink communication, a network access communication, or any combination thereof.

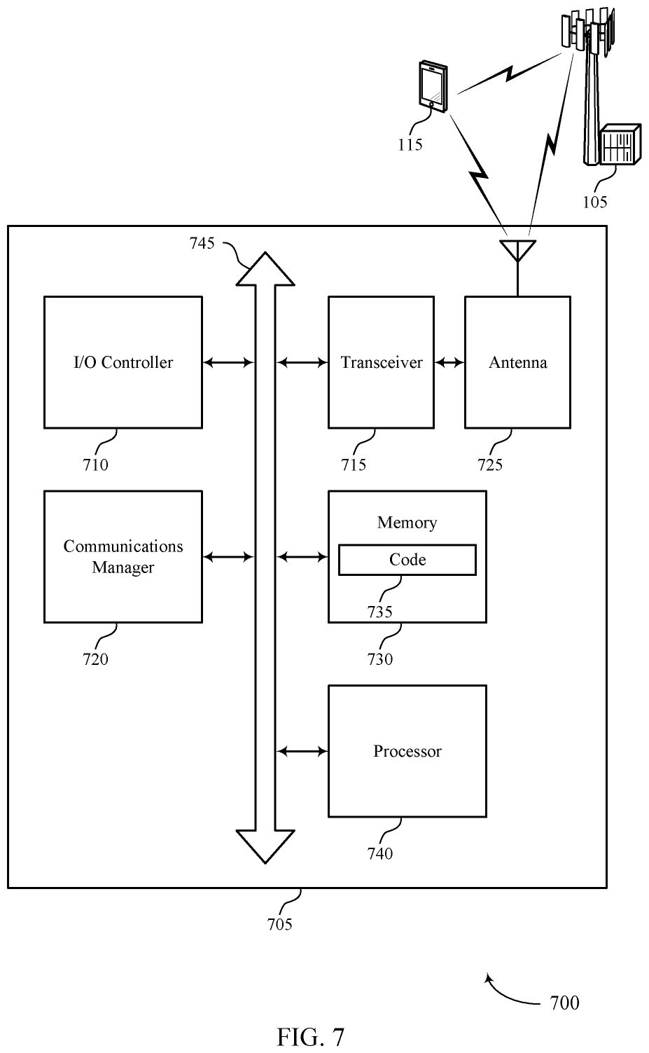

FIG. 7 shows a diagram of a system 700 including a device 705 that supports techniques for rapid communication of priority signaling in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for rapid communication of priority signaling). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a first signal from the first wireless device during operation of the first wireless device in a FD mode, where operation in the FD mode includes a capability to simultaneously operate in a transmit mode and a receive mode. The communications manager 720 is capable of, configured to, or operable to support a means for receiving, during transmission of the first signal, a control signal that is indicative that a priority signal is intended for the first wireless device. The communications manager 720 is capable of, configured to, or operable to support a means for receiving the priority signal after a transition of the first wireless device from operation in the FD mode to operation in the receive mode, where the transition is based on reception of the control signal.

Additionally, or alternatively, the communications manager 720 may support wireless communications in accordance with examples as disclosed herein. For example, the communications manager 720 is capable of, configured to, or operable to support a means for transmitting a control signal to a first wireless device during operation of the first wireless device in a FD mode and during transmission, by the first wireless device, of a first signal, where the control signal is indicative that a priority signal is intended for the first wireless device. The communications manager 720 is capable of, configured to, or operable to support a means for transmitting the priority signal to the first wireless device based on determining that an operational mode of the first wireless device is a receive mode based on transmission of the control signal.

By including or configuring the communications manager 720 in accordance with examples as described herein, the device 705 may support techniques for improved communication reliability, reduced latency, and improved coordination between devices. For example, a UE 115 implementing the techniques described herein may more often and more quickly receive and decode priority signaling, which may reduce latency associated with receiving priority signaling, improve the communication reliability of the priority signaling, and improve the coordination between a UE 115 transmitting the priority signaling and the UE 115 receiving the priority signaling.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for rapid communication of priority signaling as described herein, or the at least one processor 740 and the at least one memory 730 may be otherwise configured to, individually or collectively, perform or support such operations.

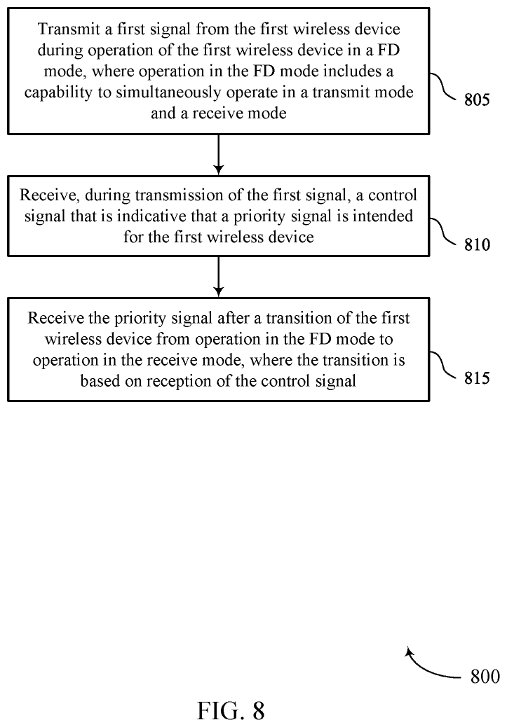

FIG. 8 shows a flowchart illustrating a method 800 that supports techniques for rapid communication of priority signaling in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include transmitting a first signal from the first wireless device during operation of the first wireless device in a FD mode, where operation in the FD mode includes a capability to simultaneously operate in a transmit mode and a receive mode. The operations of block 805 may be performed in accordance with examples as disclosed herein. In some examples, aspects of the operations of 805 may be performed by an FD communication component 625 as described with reference to FIG. 6.

At 810, the method may include receiving, during transmission of the first signal, a control signal that is indicative that a priority signal is intended for the first wireless device. The operations of block 810 may be performed in accordance with examples as disclosed herein. In some examples, aspects of the operations of 810 may be performed by a control signal component 630 as described with reference to FIG. 6.

At 815, the method may include receiving the priority signal after a transition of the first wireless device from operation in the FD mode to operation in the receive mode, where the transition is based on reception of the control signal. The operations of block 815 may be performed in accordance with examples as disclosed herein. In some examples, aspects of the operations of 815 may be performed by a priority signal reception component 635 as described with reference to FIG. 6.

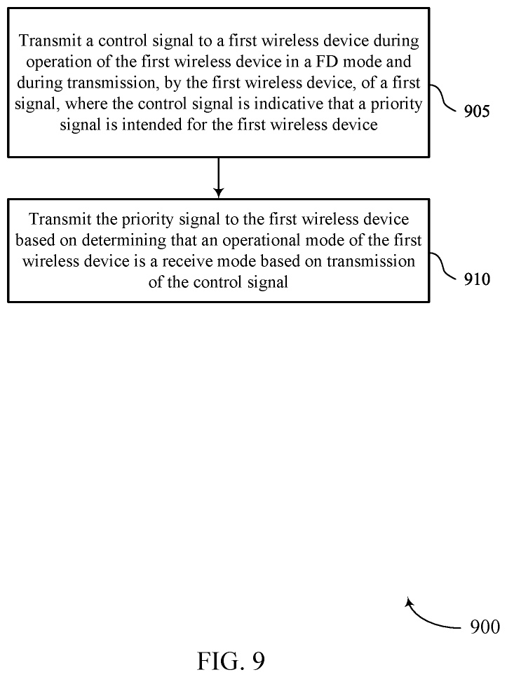

FIG. 9 shows a flowchart illustrating a method 900 that supports techniques for rapid communication of priority signaling in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include transmitting a control signal to a first wireless device during operation of the first wireless device in a FD mode and during transmission, by the first wireless device, of a first signal, where the control signal is indicative that a priority signal is intended for the first wireless device. The operations of block 905 may be performed in accordance with examples as disclosed herein. In some examples, aspects of the operations of 905 may be performed by a control signal component 630 as described with reference to FIG. 6.

At 910, the method may include transmitting the priority signal to the first wireless device based on determining that an operational mode of the first wireless device is a receive mode based on transmission of the control signal. The operations of block 910 may be performed in accordance with examples as disclosed herein. In some examples, aspects of the operations of 910 may be performed by a priority signal transmission component 640 as described with reference to FIG. 6.

The following provides an overview of aspects of the present disclosure:

Aspect 1: A method for wireless communications at a first wireless device, comprising: transmitting a first signal from the first wireless device during operation of the first wireless device in a full duplex mode, wherein operation in the full duplex mode includes a capability to simultaneously operate in a transmit mode and a receive mode; receiving, during transmission of the first signal, a control signal that is indicative that a priority signal is intended for the first wireless device; and receiving the priority signal after a transition of the first wireless device from operation in the full duplex mode to operation in the receive mode, wherein the transition is based at least in part on reception of the control signal.

Aspect 2: The method of aspect 1, wherein the control signal is a waveform, a sequence, or a reference signal that, upon reception, is indicative that the priority signal is intended for the first wireless device.

Aspect 3: The method of aspect 2, wherein the waveform, the sequence, or the reference signal are each part of a set of waveforms, a set of sequences, or a set of reference signals, respectively, and each of the set of waveforms, the set of sequences, or the set of reference signals is associated with indication of priority signaling.

Aspect 4: The method of any of aspects 2 through 3, further comprising: receiving a second control signal that indicates that the waveform, the sequence, or the reference signal is associated with indication of priority signaling on a per device bases.

Aspect 5: The method of any of aspects 1 through 4, wherein reception of the control signal during transmission of the first signal is facilitated by the control signal having a data rate that is less than a data rate threshold, reception at the first wireless device at a first data rate that is less than the data rate threshold is associated with a first detection threshold at the first wireless device, and reception at the first wireless device at a second data rate that is greater than the data rate threshold is associated with a second detection threshold that is greater than the first detection threshold.

Aspect 6: The method of aspect 5, wherein the first detection threshold is a signal-to-interference-plus-noise ratio (SINR) threshold.

Aspect 7: The method of any of aspects 1 through 6, further comprising: participating in communication of one or more second control signals that configure a monitoring window for reception of the control signal at the first wireless device.

Aspect 8: The method of aspect 7, wherein the monitoring window includes a symbol or a slot or a mini-slot boundary.

Aspect 9: The method of any of aspects 1 through 8, further comprising:

participating in communication of one or more second control signals that configure a length of the control signal, a quantity of repetitions of the control signal, or both.

Aspect 10: The method of aspect 9, wherein the length of the control signal,

the quantity of repetitions of the control signal, or both, are based at least in part on a distance between the first wireless device and a source of the control signal, a signal isolation capability of the first wireless device, a self-interference measurement associated with the first wireless device, or any combination thereof.

Aspect 11: The method of any of aspects 9 through 10, wherein the one or

more second control signals include a broadcast message broadcast by the first wireless device, an initial connection message transmitted by the first wireless device to a source of the control signal, a periodic control message transmitted by the first wireless device, a response message transmitted by the first wireless device responsive to reception of the control signal, or any combination thereof.

Aspect 12: The method of any of aspects 1 through 11, further comprising: transmitting a termination signal based at least in part on reception of the control signal, wherein the termination signal indicates a termination of transmission of the first signal.

Aspect 13: The method of aspect 12, wherein reception of the priority signal is based at least in part on transmission of the termination signal.

Aspect 14: The method of any of aspects 1 through 13, wherein at least one of the first signal, the control signal, or the priority signal is a part of a vehicle-to-everything communication, a sidelink communication, a network access communication, or any combination thereof.

Aspect 15: A method for wireless communications at a second wireless device, comprising: transmitting a control signal to a first wireless device during operation of the first wireless device in a full duplex mode and during transmission, by the first wireless device, of a first signal, wherein the control signal is indicative that a priority signal is intended for the first wireless device; and transmitting the priority signal to the first wireless device based at least in part on determining that an operational mode of the first wireless device is a receive mode based at least in part on transmission of the control signal.

Aspect 16: The method of aspect 15, further comprising: receiving the first signal from the first wireless device, wherein transmitting the control signal is based at least in part on reception of the first signal.

Aspect 17: The method of any of aspects 15 through 16, wherein the control signal is a waveform, a sequence, or a reference signal that is indicative to a receiver that the priority signal is intended for the first wireless device.

Aspect 18: The method of aspect 17, wherein the waveform, the sequence, or the reference signal are each part of a set of waveforms, a set of sequences, or a set of reference signals, respectively, and each of the set of waveforms, the set of sequences, or the set of reference signals is associated with indication of priority signaling on a per device bases.

Aspect 19: The method of any of aspects 17 through 18, further comprising: receiving a second control signal that indicates that the waveform, the sequence, or the reference signal is associated with indication of priority signaling for the first wireless device corresponding to the second wireless device.

Aspect 20: The method of any of aspects 15 through 19, wherein the control signal has a data rate that is less than a data rate threshold.

Aspect 21: The method of any of aspects 15 through 20, further comprising: participating in communication of one or more second control signals that configure a monitoring window for reception of the control signal at the first wireless device, wherein transmission of the control signal is during the monitoring window.

Aspect 22: The method of aspect 21, wherein the monitoring window includes a symbol or a slot or a mini-slot boundary.

Aspect 23: The method of any of aspects 15 through 22, further comprising: participating in communication of one or more second control signals that configure a length of the control signal, a quantity of repetitions of the control signal, or both.

Aspect 24: The method of aspect 23, wherein the length of the control signal, the quantity of repetitions of the control signal, or both, are based at least in part on a distance between the first wireless device and the second wireless device, a signal isolation capability of the first wireless device, a self-interference measurement associated with the first wireless device, or any combination thereof.

Aspect 25: The method of any of aspects 23 through 24, wherein the one or more second control signals include a broadcast message broadcast by the first wireless device, an initial connection message received from the first wireless device, a periodic control message received from the first wireless device, a response message received from the first wireless device responsive to transmission of the control signal, or any combination thereof.

Aspect 26: The method of any of aspects 15 through 25, wherein determining that the operational mode of the first wireless device is the receive mode comprises: receiving a termination signal from the first wireless device based at least in part on transmission of the control signal, wherein the termination signal indicates a termination of transmission at the first wireless device of the first signal.

Aspect 27: The method of aspect 26, wherein transmission of the priority signal is based at least in part on reception of the termination signal.

Aspect 28: The method of any of aspects 15 through 27, wherein determining that the operational mode of the first wireless device is the receive mode is based at least in part on an application time window after transmission of the control signal.

Aspect 29: The method of any of aspects 15 through 28, wherein determining that the operational mode of the first wireless device is the receive mode comprises: detecting a reduction in received energy from the first wireless device via a channel for receiving the first signal.

Aspect 30: The method of any of aspects 15 through 29, wherein at least one of the first signal, the control signal, or the priority signal is part of a vehicle-to-everything communication, a sidelink communication, a network access communication, or any combination thereof.

Aspect 31: A first wireless device for wireless communications, comprising one or more memories storing processor-executable code, and one or more processors coupled with the one or more memories and individually or collectively operable to execute the code to cause the first wireless device to perform a method of any of aspects 1 through 14.

Aspect 32: A first wireless device for wireless communications, comprising at least one means for performing a method of any of aspects 1 through 14.

Aspect 33: A non-transitory computer-readable medium storing code for wireless communications, the code comprising instructions executable by one or more processors to perform a method of any of aspects 1 through 14.

Aspect 34: A second wireless device for wireless communications, comprising one or more memories storing processor-executable code, and one or more processors coupled with the one or more memories and individually or collectively operable to execute the code to cause the second wireless device to perform a method of any of aspects 15 through 30.

Aspect 35: A second wireless device for wireless communications, comprising at least one means for performing a method of any of aspects 15 through 30.

Aspect 36: A non-transitory computer-readable medium storing code for wireless communications, the code comprising instructions executable by one or more processors to perform a method of any of aspects 15 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
transmit a first signal from the first wireless device during operation of the first wireless device in a full duplex mode, wherein operation in the full duplex mode includes a capability to simultaneously operate in a transmit mode and a receive mode;
receive, during transmission of the first signal, a control signal that is indicative that a priority signal is intended for the first wireless device; and
receive the priority signal after a transition of the first wireless device from operation in the full duplex mode to operation in the receive mode, wherein the transition is based at least in part on reception of the control signal.

2. The first wireless device of claim 1, wherein the control signal is a waveform, a sequence, or a reference signal that, upon reception, is indicative that the priority signal is intended for the first wireless device.

3. The first wireless device of claim 2, wherein the waveform, the sequence, or the reference signal are each part of a set of waveforms, a set of sequences, or a set of reference signals, respectively, and wherein each of the set of waveforms, the set of sequences, or the set of reference signals is associated with indication of priority signaling.

4. The first wireless device of claim 2, wherein the one or more processors are individually or collectively further operable to execute the code to cause the first wireless device to:
receiving a second control signal that indicates that the waveform, the sequence, or the reference signal is associated with indication of priority signaling on a per device basis.

5. The first wireless device of claim 1, wherein reception of the control signal during transmission of the first signal is facilitated by the control signal having a data rate that is less than a data rate threshold, wherein reception at the first wireless device at a first data rate that is less than the data rate threshold is associated with a first detection threshold at the first wireless device, and wherein reception at the first wireless device at a second data rate that is greater than the data rate threshold is associated with a second detection threshold that is greater than the first detection threshold.

6. The first wireless device of claim 5, wherein the first detection threshold is a signal-to-interference-plus-noise ratio (SINR) threshold.

7. The first wireless device of claim 1, wherein the one or more processors are individually or collectively further operable to execute the code to cause the first wireless device to:
participate in communication of one or more second control signals that configure a monitoring window for reception of the control signal at the first wireless device.

8. The first wireless device of claim 7, wherein the monitoring window includes a symbol or a slot or a mini-slot boundary.

9. The first wireless device of claim 1, wherein the one or more processors are individually or collectively further operable to execute the code to cause the first wireless device to:
participate in communication of one or more second control signals that configure a length of the control signal, a quantity of repetitions of the control signal, or both.

10. The first wireless device of claim 9, wherein the length of the control signal, the quantity of repetitions of the control signal, or both, are based at least in part on a distance between the first wireless device and a source of the control signal, a signal isolation capability of the first wireless device, a self-interference measurement associated with the first wireless device, or any combination thereof.

11. The first wireless device of claim 9, wherein the one or more second control signals include a broadcast message broadcast by the first wireless device, an initial connection message transmitted by the first wireless device to a source of the control signal, a periodic control message transmitted by the first wireless device, a response message transmitted by the first wireless device responsive to reception of the control signal, or any combination thereof.

12. The first wireless device of claim 1, wherein the one or more processors are individually or collectively further operable to execute the code to cause the first wireless device to:
transmit a termination signal based at least in part on reception of the control signal, wherein the termination signal indicates a termination of transmission of the first signal.

13. The first wireless device of claim 12, wherein reception of the priority signal is based at least in part on transmission of the termination signal.

14. A second wireless device, comprising:
one or more memories storing processor-executable code; and
one or more processors coupled with the one or more memories and individually or collectively operable to execute the code to cause the second wireless device to:
transmit a control signal to a first wireless device during operation of the first wireless device in a full duplex mode and during transmission, by the first wireless device, of a first signal, wherein the control signal is indicative that a priority signal is intended for the first wireless device; and
transmit the priority signal to the first wireless device based at least in part on determining that an operational mode of the first wireless device is a receive mode based at least in part on transmission of the control signal.

15. The second wireless device of claim 14, wherein the one or more processors are individually or collectively further operable to execute the code to cause the second wireless device to:
receive the first signal from the first wireless device, wherein transmitting the control signal is based at least in part on reception of the first signal.

16. The second wireless device of claim 14, wherein the control signal is a waveform, a sequence, or a reference signal that is indicative to a receiver that the priority signal is intended for the first wireless device.

17. The second wireless device of claim 16, wherein the waveform, the sequence, or the reference signal are each part of a set of waveforms, a set of sequences, or a set of reference signals, respectively, and wherein each of the set of waveforms, the set of sequences, or the set of reference signals is associated with indication of priority signaling on a per device basis.

18. The second wireless device of claim 16, wherein the one or more processors are individually or collectively further operable to execute the code to cause the second wireless device to:
receive a second control signal that indicates that the waveform, the sequence, or the reference signal is associated with indication of priority signaling for the first wireless device corresponding to the second wireless device.

19. The second wireless device of claim 14, wherein the control signal has a data rate that is less than a data rate threshold.

20. The second wireless device of claim 14, wherein the one or more processors are individually or collectively further operable to execute the code to cause the second wireless device to:
participate in communication of one or more second control signals that configure a monitoring window for reception of the control signal at the first wireless device, wherein transmission of the control signal is during the monitoring window.

21. The second wireless device of claim 20, wherein the monitoring window includes a symbol or a slot or a mini-slot boundary.

22. The second wireless device of claim 14, wherein the one or more processors are individually or collectively further operable to execute the code to cause the second wireless device to:
participate in communication of one or more second control signals that configure a length of the control signal, a quantity of repetitions of the control signal, or both.

23. The second wireless device of claim 22, wherein the length of the control signal, the quantity of repetitions of the control signal, or both, are based at least in part on a distance between the first wireless device and the second wireless device, a signal isolation capability of the first wireless device, a self-interference measurement associated with the first wireless device, or any combination thereof.

24. The second wireless device of claim 22, wherein the one or more second control signals include a broadcast message broadcast by the first wireless device, an initial connection message received from the first wireless device, a periodic control message received from the first wireless device, a response message received from the first wireless device responsive to transmission of the control signal, or any combination thereof.

25. The second wireless device of claim 14, wherein, to determine that the operational mode of the first wireless device is the receive mode, the one or more processors are individually or collectively operable to execute the code to cause the second wireless device to:
receive a termination signal from the first wireless device based at least in part on transmission of the control signal, wherein the termination signal indicates a termination of transmission at the first wireless device of the first signal.

26. The second wireless device of claim 25, wherein transmission of the priority signal is based at least in part on reception of the termination signal.

27. The second wireless device of claim 14, wherein determining that the operational mode of the first wireless device is the receive mode is based at least in part on an application time window after transmission of the control signal.

28. The second wireless device of claim 14, wherein, to determine that the operational mode of the first wireless device is the receive mode, the one or more processors are individually or collectively operable to execute the code to cause the second wireless device to:
detect a reduction in received energy from the first wireless device via a channel for receiving the first signal.

29. A method for wireless communications at a first wireless device, comprising:
transmitting a first signal from the first wireless device during operation of the first wireless device in a full duplex mode, wherein operation in the full duplex mode includes a capability to simultaneously operate in a transmit mode and a receive mode;
receiving, during transmission of the first signal, a control signal that is indicative that a priority signal is intended for the first wireless device; and
receiving the priority signal after a transition of the first wireless device from operation in the full duplex mode to operation in the receive mode, wherein the transition is based at least in part on reception of the control signal.

30. A method for wireless communications at a second wireless device, comprising:
transmitting a control signal to a first wireless device during operation of the first wireless device in a full duplex mode and during transmission, by the first wireless device, of a first signal, wherein the control signal is indicative that a priority signal is intended for the first wireless device; and
transmitting the priority signal to the first wireless device based at least in part on determining that an operational mode of the first wireless device is a receive mode based at least in part on transmission of the control signal.
